(19) United States
(12) Patent Application Publication
(10) Pub. No.: US 2016/0008899 A1
(43) Pub. Date: Jan. 14, 2016

(54) Variable Pitch Blade

(71) Applicants: Roy A. Hunter, Moreland, GA (US); John A. Graves, Carrollton, GA (US); Mark K. Dobson, Dardenne Prairie, MO (US); Eleazar C. Longoria, Brownsville, TX (US); Robert M. VanCamp, St. Louis, MO (US)

(72) Inventors: Roy A. Hunter, Moreland, GA (US); John A. Graves, Carrollton, GA (US); Mark K. Dobson, Dardenne Prairie, MO (US); Eleazar C. Longoria, Brownsville, TX (US); Robert M. VanCamp, St. Louis, MO (US)

(21) Appl. No.: 14/628,596

(22) Filed: Feb. 23, 2015

Related U.S. Application Data
(60) Provisional application No. 62/024,118, filed on Jul. 14, 2014.

(51) Int. Cl. B23D 61/12

(52) U.S. Cl. CPC B23D 61/121

(57) ABSTRACT

A saw blade comprises an elongated band having a multiplicity of teeth sets. In a preferred embodiment, each teeth set comprises a modified raker set of teeth comprising a continuous series of right, left, raker, right and left teeth, each having a different pitch. Each tooth preferably has a transverse tooth face substantially perpendicular to the feed direction of the blade and also has a notch. In one embodiment, the left and right teeth may have a uniform hook angle and each tooth of the given blade set has the same lateral blade displacement.

### BACKGROUND

This disclosure relates generally to band saw blades. More particularly, this disclosure relates to band saw blades which are employed for cutting meat products and other cutting applications.

The use and technology related to band saws and their associated blades for meat cutting and other related applications are well known and well developed. The proposed variable pitch blade of the present disclosure preferably has a geometry which can be incorporated for configuring a band saw blade which may, for example, be used in cutting pork.

The proposed band saw blade seeks to address one or more deficiencies of related conventional blades. Upon usage, the proposed blade operates to generate a reduced noise and vibration level as compared to many conventional blades. The blade cutting characteristics provide an improved surface finish to the severed products. In addition, less bone dust will typically be imparted to the finished product. Less operator effort will ordinarily be required to feed the product toward the blade during the cutting process.

### SUMMARY

Briefly stated, a saw blade in a preferred form, comprises an elongated band having a multiplicity of tooth sets. Each of the tooth sets comprises a modified raker set of teeth comprising a continuous series of right, left, raker, right, left teeth, each having a different pitch. Each tooth has a transverse tooth face substantially perpendicular to the blade feed direction. Each tooth has a notch. Each of the left and right teeth also has an acute hook angle.

Each notch is preferably substantially identical. Each hook angle may range from 3° to 10°, and in one embodiment, is approximately 5°. Each of the teeth has a lateral tooth displacement which is preferably substantially equal for all of the teeth. In one preferred embodiment, the pitch of one right tooth equals 1.1 times the pitch of the left tooth immediately adjacent the raker tooth. In one preferred embodiment, the blade has a width of from approximately ½ inch to approximately 1 inch wide and a length of approximately 60 inches to approximately 180 inches.

A saw blade generally comprises a multiplicity of longitudinally disposed tooth sets S₁, S₂, S₃, S₄, S₅ . . . Sₙ wherein n is a positive integer. Each tooth set Sₙ comprises a modified raker set of teeth T₁, T₂, T₃, T₄, and T₅ comprising a continuous series of first hand, second hand, raker, first hand, second hand teeth, respectively. Each of the teeth has a different pitch P₁, P₂, P₃, P₄ and P₅, respectively. Each tooth T₁, T₂, T₃, T₄, and T₅ is a cutting tooth with a transverse tooth face substantially perpendicular to the feed direction. Each of the teeth T₁, T₂, T₄, and T₅ has a hook angle A₁, A₂, A₄ and A₅, respectively.

In one embodiment, each of the teeth T₁, T₂, T₃, T₄, and T₅ has a notch N₁, N₂, N₃, N₄ and N₅, respectively. The notches, in one embodiment, are substantially identical. The hook angles A₁, A₂, A₄ and A₅ preferably range from 3° to 10°.

In one preferred embodiment, each of the teeth T₁, T₂, T₃, T₄, and T₅ has a lateral displacement D₁, D₂, D₃, D₄ and D₅, respectively, which is substantially identical. The pitch P₁ of tooth T₁ equals 1.1 times the pitch P₂ of T₂ in one embodiment.

In another preferred embodiment, a saw blade comprises an elongated band having a multiplicity of longitudinally disposed tooth sets S₁, S₂, S₃, S₄, S₅ . . . Sₙ wherein n is a positive integer. Each tooth set Sₙ comprises a modified raker set of teeth T₁, T₂, T₃, T₄, and T₅, each of which has a different pitch P₁, P₂, P₃, P₄ and P₅, respectively. Each tooth T₁, T₂, T₃, T₄, and T₅ is a cutting tooth with a transverse tooth face substantially perpendicular to the feed direction. Each said tooth T₁, T₂, T₄, and T₅ has a hook angle A₁, A₂, A₄ and A₅. Each of the teeth T₁, T₂, T₃, T₄, and T₅ preferably has a notch which is substantially identical. Each of the hook angles A₁ and A₂ has an equal angle and opposite angle direction and each of said hook angles A₄ and A₅ as an equal angle and opposite angle direction. Each of the teeth T₁, T₂, T₃, T₄, and T₅ has a lateral blade displacement which, in some embodiments, is substantially equal for each of the teeth.

### BRIEF DESCRIPTION OF THE DRAWINGS

FIG. 1 is a side view of a representative portion of a variable pitch blade;

FIG. 2 is a top plan view of the blade portion of FIG. 1;

FIG. 3 is an enlarged portion of the circled area of the blade portion of FIG. 2, partly in diagram form;

FIG. 4 is a partial side elevational view of a blade profile, partly in diagram form to indicate dimensions for a specific embodiment, of the blade portion of FIG. 1;

FIG. 5 is a partial side diagrammatic schematic view of a blade profile for the blade of FIG. 1;

FIG. 6 is a side diagrammatic view of a representative portion of a variable pitch blade;

FIG. 7 is a partial side diagrammatic view of a blade profile for the blade of FIG. 6; and

FIG. 8 is a top plan view, partly diagrammatic, of the blade portion of FIG. 7.

### DETAILED DESCRIPTION

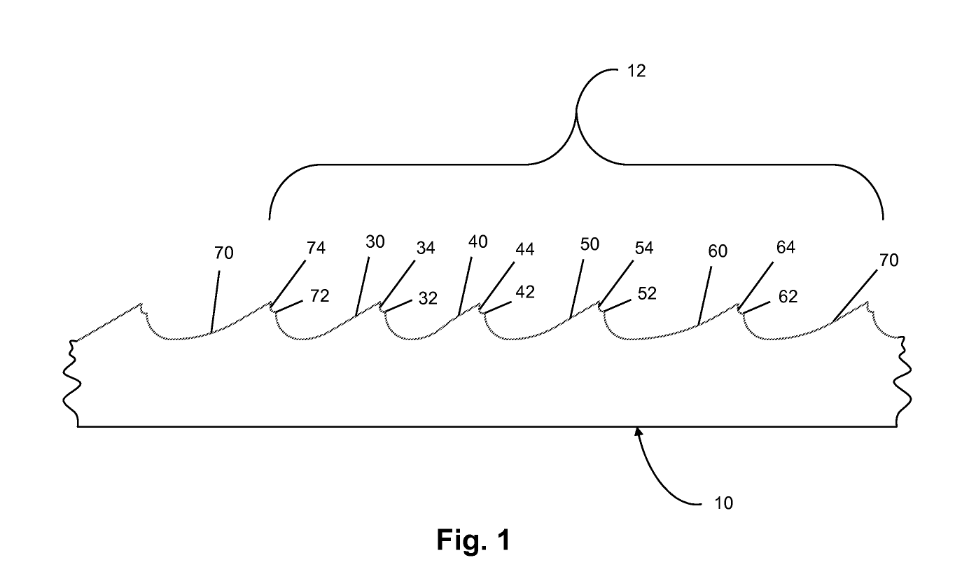

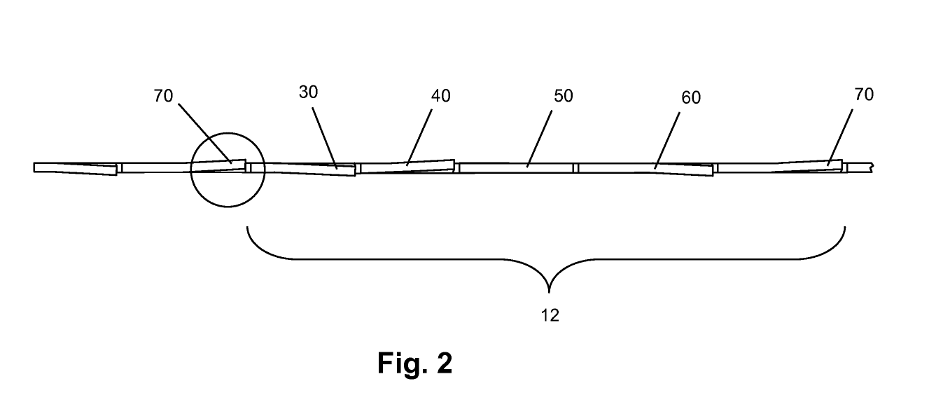

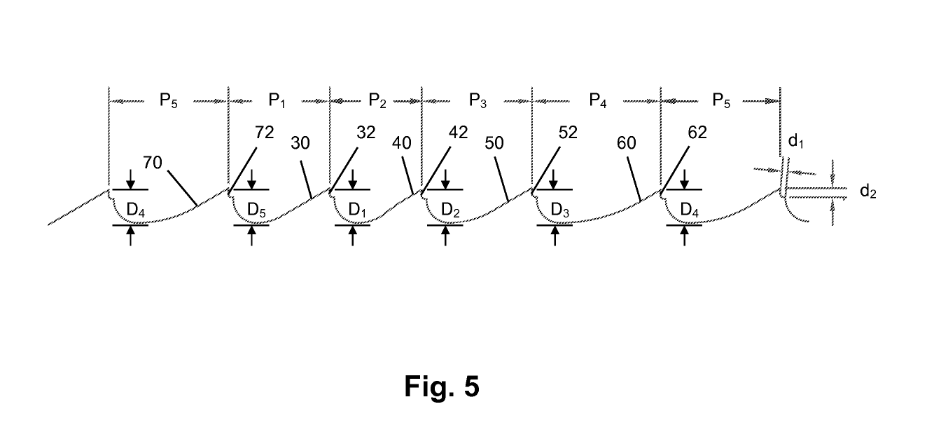

With reference to the drawings, wherein like numerals represent like parts throughout the several figures, a variable pitch blade which is especially configured for band saw applications is generally designated by the numeral 10. The blade 10 is preferably manufactured from steel. A representative segment 12 of a blade embodiment is principally illustrated in the drawings of FIGS. 1-5. It is understood that the blade 10 preferably comprises a series of continuous multiple identical representative segments. In a preferred application for which the band saw blade 10 has typical applicability, the blade dimensions range from ½ inch to 1 inch wide, from 0.016 inches to 0.035 inches in thickness, and from 60 inches to 180 inches in length. Each representative segment 12 constitutes a five-tooth modified raker teeth set and is serially replicated throughout the length of the blade.

The representative segment 12 comprises a first right tooth 30 having a pitch P₁, a first left tooth 40 having a pitch P₂, a raker tooth 50 having a pitch P₃ and a second right tooth 60 having a pitch P₄ and a second left tooth 70 having a pitch P₅. The pitches P₁-P₅ are unequal. The left and right designations are arbitrary. The left and right teeth preferably have a hook angle which ranges from 3° to 10° and, in one embodiment, have a uniform 5° hook angle A. In a preferred form of blade 10, the forgoing teeth are serially replicated longitudinally along the length of the blade. It will be appreciated that the initial tooth designation within the five-tooth modified raker teeth set is arbitrary.

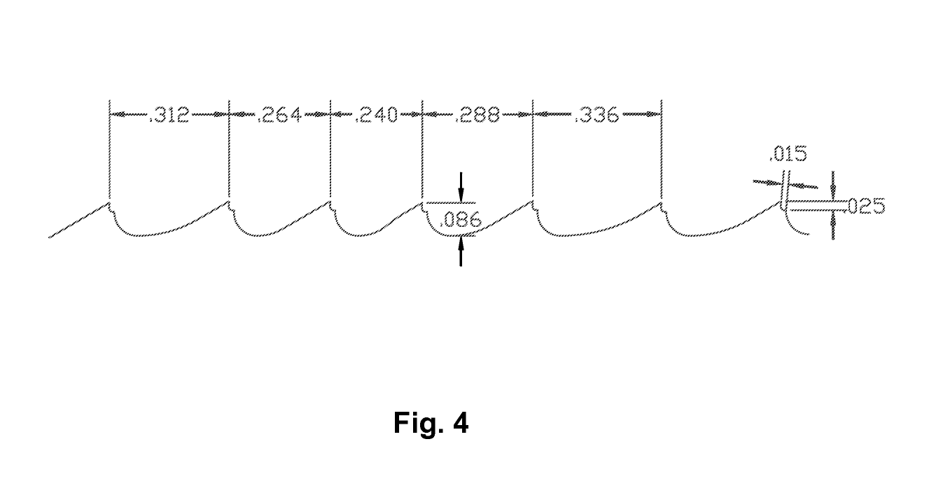

Each of the teeth 30, 40, 50, 60 and 70 preferably has a corresponding indentation or notch 32, 42, 52, 62 and 72, respectively. In one preferred embodiment, the notches are substantially identical and have a dimension of 0.15 inches×0.025 inches, as illustrated in FIG. 4. In other embodiments, the notches may be different for each of the teeth in the set, and of course, may assume different dimensions d₁ and d₂.

Each of the teeth 30, 40, 50, 60 and 70 have a lateral displacement D₁, D₂, D₃, D₄ and D₅, respectively. In the illustrated preferred embodiment, the lateral displacement D for each of the teeth is identical and is 0.086 inches, although it is possible that the lateral displacements will be unequal for a given blade.

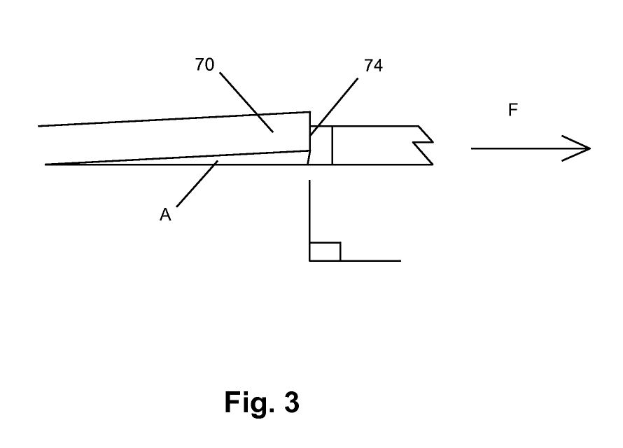

As best illustrated in FIG. 3, it should be noted that the tooth face 34 is perpendicular to the feed direction indicated by the arrow. Each of the teeth has a respective transverse cutting face 34, 44, 54, 64 and 74 perpendicular to the feed direction F. It is believed that the perpendicular cutting face orientation will allow for the operator to feed the product during the cutting process with less effort.

In the illustrated embodiment, the variable pitches P₁-P₅ are 0.264 inches, 0.248 inches, 0.256 inches, 0.336 inches and 0.312 inches, respectively. It should be noted that the pitches may, of course, be different dimensions. In one preferred application, P₁=P₂×1.10 and P₅=P₃×1.20.

It is preferred for each non-raker tooth that the cutting face is 5° from the vertical towards the direction of travel. Other acute angles are possible and the hook angles may not be uniform for some embodiments. The teeth 30, 40, 50, 60 and 70 of each modified raker set are generally ground to form the blade geometry.

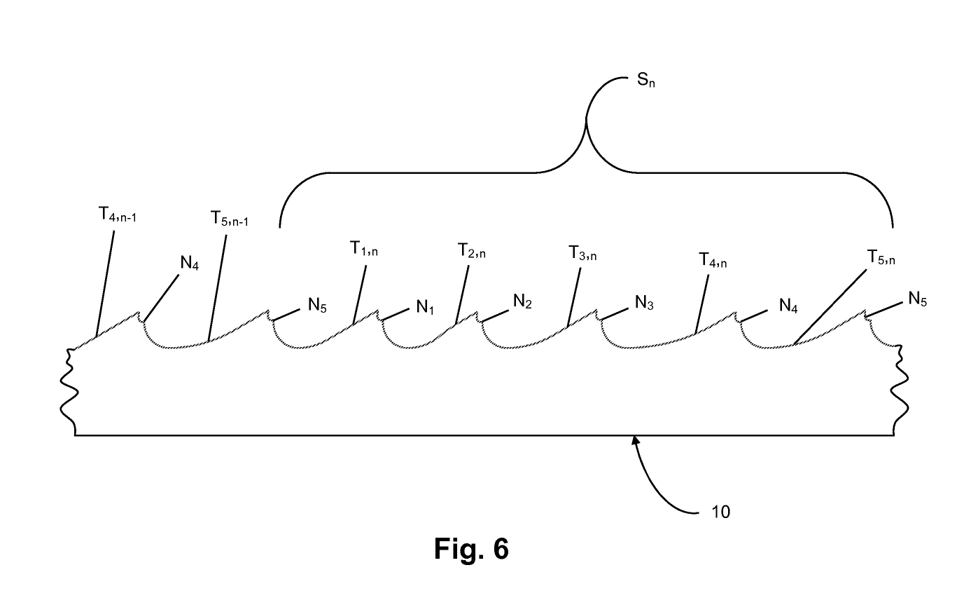

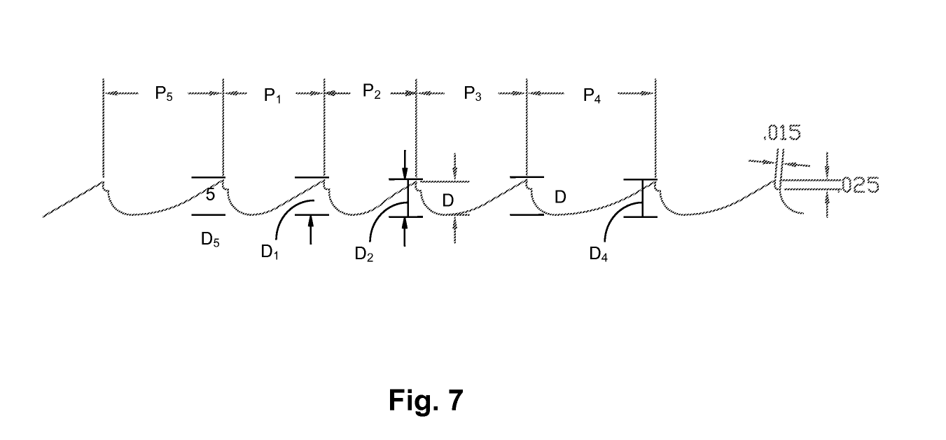

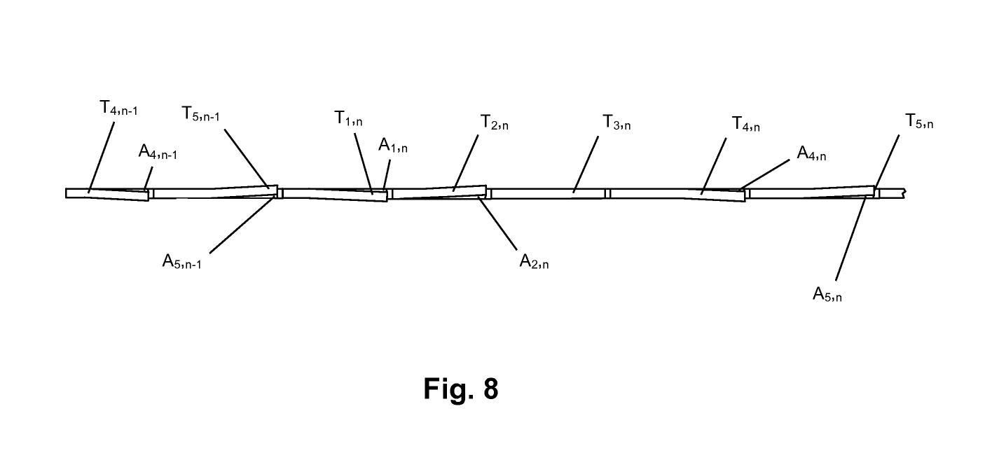

With reference to FIGS. 6-8, a generalized variable pitch blade which is configured to illustrate various possible alternatives to blade 10 is generally designated by the numeral 100. Blade 100 comprises a series of continuous blade sets Sₘ, where m equals a positive integer. Each blade set Sₘ comprises five teeth and constitutes a modified raker set. The initial tooth designation for each raker set is arbitrary.

For purposes of better explaining the various possibilities, the teeth have been given a designation T_{1,n}; T_{2,n}; T_{3,n}; T_{4,n} and T_{5,n} where n equals a positive integer and designates a given set, and the raker tooth for each set Sₘ is designated as tooth T_{3,n}. The tooth angular designations as to left and right are entirely arbitrary. Consequently, teeth T_{1,n} and T_{4,n} are angled at one direction and teeth T_{2,n} and T_{5,n} have the opposite angle direction.

The pitch for any one given set Sₙ is designated as P_{1,n}; P_{2,n}; P_{3,n}; P_{4,n} and P_{5,n}. Each of the teeth T_{1,n}; T_{2,n}; T_{3,n}; T_{4,n} and T_{5,n} have a lateral displacement D_{1,n}; D_{2,n}; D_{3,n}; D_{4,n} and D_{5,n,} respectively. For each tooth set, each of the teeth Tₙ has a transverse cutting face substantially perpendicular to the feed direction F.

Each of the teeth T_{1,n}; T_{2,n}; T_{3,n}; T_{4,n} and T_{5,n} at the forward distal location preferably have a notch N₁, N₂, N₃, N₄ and N₅, respectively.

In one alternative embodiment, the teeth sets sₘ need not be identical, but nevertheless include a first tooth of one angle direction, a second tooth of an opposite angle direction, a raker tooth, a fourth tooth of the first angle direction and the fifth tooth of the opposite angle direction. In another alternative embodiment, the angles A₁ₙ; A₂ₙ; A₄ₙ and A₅ₙ need not be identical or equal.

In another alternative embodiment, each tooth T_{1,n}; T_{2,n}; T_{3,n}; T_{4,n} and T_{5,n} need not have an identical shape.

In another alternative embodiment, the pitches P_{1,n}; P_{2,n}; P_{3,n}; P_{4,n} and P₅,ₙ need not be the same for each set of teeth Sₘ, but within a given set will be unequal.

In another alternative embodiment, the lateral displacements D_{1,n}; D₂; D_{3,n}; D_{4,n}; and D_{5,n} need not be identical.

While preferred embodiments of the foregoing have been set forth for purposes of illustration, the foregoing description should not be deemed a limitation of the invention herein. Accordingly, various modifications, adaptations and alternatives may occur to one skilled in the art without departing from the spirit and the scope of the present invention.

1. A saw blade comprising:
an elongated band having a multiplicity of teeth sets and defining a longitudinal feed direction;
each teeth set comprising a raker set of teeth comprising a continuous series of right, left, raker, right, left teeth, each having a different pitch;
each said tooth having a cutting tooth with a transverse tooth face substantially perpendicular to the feed direction;
each said tooth defining a notch; and
each said left and right tooth defining an acute hook angle.

2. The saw blade of claim 1 wherein each said notch is substantially identical.

3. The saw blade of claim 1 wherein each said hook angle ranges from approximately 3° to 10°.

4. The saw blade of claim 1 wherein each said tooth has a lateral tooth displacement and each said lateral blade displacement is substantially equal.

5. The saw blade of claim 1 wherein the pitch of the right tooth equals 1.10 times the pitch of the left tooth adjacent the raker tooth.

6. The saw blade of claim 1 wherein the blade has a width of from approximately ½ inch to approximately 1 inch wide and a length of approximately 60 inches to approximately 180 inches.

7. A saw blade comprising:
an elongated band having a multiplicity of longitudinally disposed teeth sets S₁, S₂, S₃, S₄, S₅ . . . Sₙ and defining a longitudinal feed direction wherein n is a positive integer;
each teeth set Sₙ comprising a modified raker set of teeth T₁, T₂, T₃, T₄ and T₅ comprising a continuous series of first hand, second hand, raker, first hand, second hand teeth, respectively, each having a different pitch P₁, P₂, P₃, P₄ and P₅, respectively;
each said tooth T₁, T₂, T₃, T₄ and T₅ being a cutting tooth with a transverse tooth face substantially perpendicular to the feed direction; and
each said tooth T₁, T₂, T₄ and T₅ defining a hook angle A₁, A₂, A₄ and A₅, respectively.

8. The saw blade of claim 7 wherein each said tooth T₁, T₂, T₃, T₄ and T₅ defines a notch N₁, N₂, N₃, N₄ and N₅, respectively.

9. The saw blade of claim 8 wherein each said notch N₁, N₂, N₃, N₄ and N₅ is substantially identical.

10. The saw blade of claim 1 wherein each said hook angle A₁, A₂, A₄ and A₅ ranges from approximately 3° to 10°.

11. The saw blade of claim 7 wherein each said tooth T₁, T₂, T₃, T₄ and T₅ has a lateral displacement D₁, D₂, D₃, D₄ and D₅, respectively.

12. The saw blade of claim 11 wherein each said lateral blade displacement D₁, D₂, D₃, D₄ and D₅ is substantially equal.

13. The saw blade of claim 7 wherein the pitch P₁ of the tooth T₁ equals 1.10 times the pitch P₂ of tooth T₂.

14. The saw blade of claim 7 wherein the blade has a width of from approximately ½ inch to approximately 1 inch wide and a length of approximately 60 inches to approximately 180 inches.

15. A saw blade comprising:
an elongated band having a multiplicity of longitudinally disposed teeth sets S₁, S₂, S₃, S₄, S₅ . . . Sₙ and defining a longitudinal feed direction wherein n is a positive integer;
each teeth set Sₙ comprising a modified raker set of teeth T₁, T₂, T₃, T₄ and T₅, each having a different pitch P₁, P₂, P₃, P₄ and P₅, respectively;
each said tooth T₁, T₂, T₃, T₄ and T₅ being a cutting tooth with a transverse tooth face substantially perpendicular to the feed direction; and
each said tooth T₁, T₂, T₄ and T₅ defining a hook angle A₁, A₂, A₄ and A₅, respectively.

16. The saw blade of claim 15 wherein each said tooth T₁, T₂, T₃, T₄ and T₅ defines a notch N₁, N₂, N₃, N₄ and N₅, respectively.

17. The saw blade of claim 16 wherein each said notch N₁, N₂, N₃, N₄ and N₅ is substantially identical.

18. The saw blade of claim 15 wherein each said hook angle A₁ and A₂ has an equal and opposite angle direction, and each said hook angle A₄ and A₅ has an equal and opposite angle direction.

19. The saw blade of claim 15 wherein each said tooth T₁, T₂, T₃, T₄ and T₅ has a lateral blade displacement D₁, D₂, D₃, D₄ and D₅, respectively.

20. The saw blade of claim 19 wherein each said lateral blade displacement D₁, D₂, D₃, D₄ and D₅ is substantially equal.
